(19) United States
(12) Patent Application Publication
(10) Pub. No.: US 2020/0001652 A1
(43) Pub. Date: Jan. 2, 2020

(54) PNEUMATIC TIRE

(71) Applicant: Toyo Tire Corporation, Itami-shi (JP)

(72) Inventor: Kazuki Ohta, Itami-shi (JP)

(73) Assignee: Toyo Tire Corporation, Itami-shi (JP)

(21) Appl. No.: 16/453,241

(22) Filed: Jun. 26, 2019

(30) Foreign Application Priority Data
Jun. 29, 2018 (JP) 2018-124949

(51) Int. Cl. B60C 11/01

(52) U.S. Cl. CPC B60C 11/01; B60C 2200/06

(57) ABSTRACT

According to one embodiment, a pneumatic tire which includes a tread portion, a sidewall portion, a buttress portion provided between the tread portion and the sidewall portion, and a scooped portion which is provided in the buttress portion to extend along a tire circumferential direction, where a cross-sectional shape of a bottom surface of the scooped portion forms a curved shape in which a plurality of arcs having different radii of curvature are arranged such that the radii of curvature decreases as it goes from a tire radial outer side to an inner side and the adjacent arcs are connected at contact points having a common tangent.

### BACKGROUND OF THE INVENTION

### 1. Field of the Invention

The present invention relates to a pneumatic tire.

### 2. Description of Related Art

A pneumatic tire usually has a high ground contact pressure in a vicinity of a ground contact end of a tread portion when traveling. Therefore, uneven wear where the amount of wear in the vicinity of the ground contact end is larger than that of other portions may be a problem. As a method to prevent such uneven wear, a tire has been proposed in which, by providing a recess portion sinking on the tire width inner side in the buttress portion, which is provided between the tread portion and the sidewall portion, the ground contact pressure is reduced as the rigidity in the vicinity of the ground contact end of the tread portion decreases and the occurrence of uneven wear is reduced (for example, see JP-A-2009-173265 and JP-A-2009-56955).

However, in JP-A-2009-173265 and JP-A-2009-56955, the cross-sectional shape of the bottom surface of the recess portion provided in the buttress portion is formed in a single arc shape. Therefore, the strain generated by a load received in the vicinity of the ground contact end of the tread portion tends to be concentrated on a top of the bottom surface of the recess portion and breakage originating from the top of the bottom is likely to occur.

The invention is made in view of the points described above and an object thereof is to provide a pneumatic tire in which a recess portion is provided in a buttress portion to reduce the rigidity in a vicinity of a ground contact end of a tread portion to reduce the occurrence of uneven wear and durability can be improved by reducing local concentration of strain on a top portion of a bottom surface of the recess portion.

### SUMMARY OF THE INVENTION

A pneumatic tire according to the invention includes a tread portion, a sidewall portion, a buttress portion provided between the tread portion and the sidewall portion, and a scooped portion which sinks from an outer surface of the buttress portion to a tire width inner side, where a cross-sectional shape of a bottom surface of the scooped portion forms a curved shape in which a plurality of arcs having different radii of curvature are arranged such that the radius of curvature decreases as it goes from a tire radial outer side to an inner side and adjacent arcs are connected at contact points having a common tangent.

As described above, since the cross-sectional shape of the bottom surface of the scooped portion which sinks from the outer surface of the buttress portion to the tire width inner side is provided in a curved shape in which the plurality of arcs having different radii of curvature are arranged such that the radius of curvature decreases as it goes from the tire radial outer side to the inner side and the adjacent arcs are connected at the contact points having a common tangent, strain generated by a load received in the vicinity of the ground contact end of the tread portion is dispersed into a wide range of the scooped portion such that durability of the pneumatic tire can be improved.

### BRIEF DESCRIPTION OF THE DRAWINGS

FIG. 1 is a half sectional view of a pneumatic tire according to a first embodiment of the invention;

FIG. 2 is an enlarged view of an essential part of FIG. 1;

FIG. 3 is a half sectional view of a pneumatic tire according to a second embodiment of the invention; and

FIG. 4 is an enlarged view of an essential part of FIG. 3.

### DESCRIPTION OF EMBODIMENTS

### First Embodiment

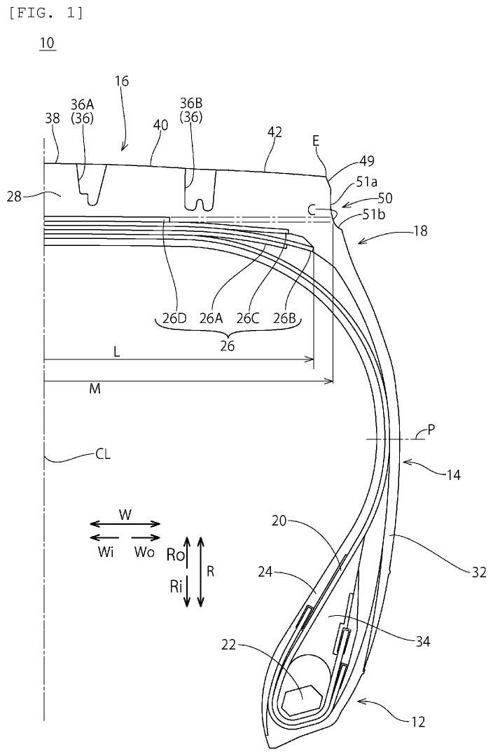

Hereinafter, a first embodiment of the invention will be described with reference to the drawings. FIG. 1 is a tire meridional cross-sectional view illustrating an example of a pneumatic tire 10 according to the embodiment and illustrates only the right half.

The pneumatic tire 10 of FIG. 1 includes a pair of left and right bead portions 12, a pair of left and right sidewall portions 14 extending radially outward from the bead portion 12, a tread portion 16 which constitutes a tread surface, and a pair of left and right buttress portions 18 disposed on a tire radial inner side Ri of the tread portion 16. Here, the buttress portion 18 is a boundary area between the tread portion 16 and the sidewall portion 14 and is provided to connect between the tread portion 16 and the sidewall portion 14.

The pneumatic tire 10 includes a carcass ply 20 provided in a toroidal manner between the pair of bead portions 12. A ring-shaped bead core 22 is embedded in each of the pair of bead portions 12.

The carcass ply 20 extends from the tread portion 16, passes through the buttress portion 18 and the sidewall portion 14, and is locked by the bead core 22 at the bead portion 12. The carcass ply 20 reinforces the respective portions 12, 14, 16, and 18. In this example, the carcass ply 20 is locked by bending both end portions around the bead cores 22 from a tire width inner side Wi to an outer side Wo. An inner liner 24 for holding air pressure is disposed inside the carcass ply 20.

The carcass ply 20 includes at least one ply formed by arranging metal cords such as steel cords or organic fiber cords such as polyester fibers, rayon fibers, aramid fibers, and nylon fibers at a predetermined angle (for example, 70° to 90°) regarding a tire circumferential direction and coating them with topping rubber. In this example, the carcass ply 20 is constituted of one ply. As the cord which constitutes the carcass ply 20, for example, metal cord such as steel cord is preferably used.

A sidewall rubber 32 is provided on an outer side (that is, a tire outer surface side) of the carcass ply 20 in the sidewall portion 14. In the bead portion 12, a bead filler 34 made of hard rubber material which extends in a tapered manner toward a tire radial outer side is disposed on an outer circumferential side of the bead core 22.

A belt 26 is disposed on the outer circumferential side of the carcass ply 20 in the tread portion 16. That is, the belt 26 is provided between the carcass ply 20 and the tread rubber 28 in the tread portion 16. The belt 26 is constituted of a plurality of crossed belt plies in which belt cords are arranged at a predetermined angle (for example, 10° to 35°) regarding the tire circumferential direction. Steel cord or organic fiber cord having high tension is used as the belt cord.

In this example, the belt 26 has a four-layer structure constituted of a first belt 26A located closest to the tire radial inner side Ri, a second belt 26B and a third belt 26C which are stacked in order on the outer circumference side of the first belt 26A, and a fourth belt 26D located closest to the tire radial outer side Ro. The second belt 26B is the widest maximum width belt.

The surface of the tread portion 16 is provided with a plurality of main grooves 36 extending along the tire circumferential direction. Specifically, the main grooves 36 are constituted of a pair of center main grooves 36A arranged on both sides across a tire equatorial plane CL and a pair of shoulder main grooves 36B provided on the tire width outer side Wo of the pair of center main grooves 36A. The tire width outer side Wo means a side away from the tire equatorial plane CL in the tire width direction W.

By the four main grooves 36 described above, in the tread portion 16, a central land portion 38 is formed between two center main grooves 36A, an intermediate land portion 40 is formed between the center main groove 36A and the shoulder main groove 36B, and shoulder land portions 42 are formed on the tire width outer sides Wo of the two shoulder main groove 36B.

In this example, the central land portion 38, the intermediate land portion 40, and the shoulder land portion 42 are formed of ribs continuous in the tire circumferential direction. The central land portion 38, the intermediate land portion 40, and the shoulder land portion 42 may be block rows divided in the tire circumferential direction by lateral grooves.

The tire width outer end of the tread surface of the shoulder land portion 42 forms a ground contact end E. The buttress portion 18 extending to the tire radial inner side Ri and constituting an upper portion of a tire lateral surface is connected to the ground end E.

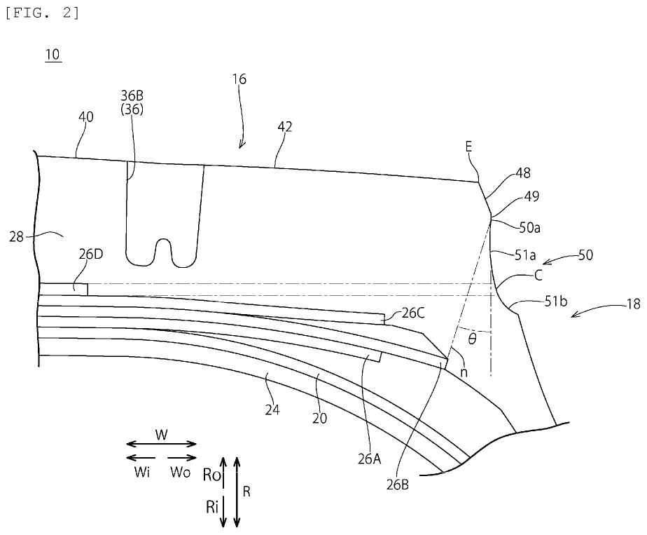

As illustrated in FIGS. 1 and 2, the outer surface of the buttress portion 18 is formed with an inclined portion 48 extending from the ground contact end E to the tire radial inner side Ri and a scooped portion 50 provided further inward in the tire radial than the inclined portion 48.

The inclined portion 48 is inclined such that the tire width outer side Wo thereof is expanded as it extends from the ground contact end E to the tire radial inner side Ri (that is, in other words, the diameter is reduced as it extends to the tire radial outer side Wo). The inclined portion 48 weakens the rigidity on the ground contact end E side of the shoulder land portion 42 to improve the wandering performance when crossing over a step on the road surface such as a weir.

In the embodiment, as illustrated in FIG. 2, the tip end side (tire width outer side) of the inclined portion 48 is provided with a bent portion 49 bent toward the tire radial inner side Ri and a tire radial outer end 50a of the scooped portion 50 is connected to the tip end of the bent portion 49.

The scooped portion 50 is a tire-circumferentially extending recessed groove which sinks closer to the tire width inner side Wi than the outer surface of the buttress portion 18. Preferably, the scooped portion 50 sinks closer to the tire width inner side Wi than the outer surface of buttress portion 18, such that at least a part of the bottom surface of the scooped portion 50 is located closer to the tire width inner side Wi than a straight line extending from the tire radial outer end 50a of the scooped portion 50 to the tire radial inner side Ri.

The cross-sectional shape of the bottom surface of the scooped portion 50 forms a curved shape in which a plurality of arcs of different radii of curvature are arranged so that the radius of the curvature becomes smaller as it goes from the tire radial outer side Ro to the inner side Ri and the adjacent arcs are connected at contact points having a common tangent.

Specifically, the bottom surface of the scooped portion 50 is constituted of an upper arc portion 51a provided on the tire radial outer side Ro and a lower arc portion 51b provided on the tire radial inner side Ri of the upper arc portion 51a. The upper arc portion 51a is a curved surface of which the cross section is an arc having a curvature radius ra and the lower arc portion 51b is a curved surface of which the cross section is an arc having a curvature radius rb smaller than the curvature radius ra. For example, the curvature radius ra of the cross section of the upper arc portion 51a can be set to 30 mm and the curvature radius rb of the cross section of the lower arc portion 51b can be set to 6 mm.

The upper arc portion 51a and the lower arc portion 51b which constitute the bottom surface of the scooped portion 50 are connected at a connection portion C to have a common tangent, and are connected smoothly without a protrusion protruding from the bottom surface of the scooped portion 50 to the tire width outer side Wo at the connection portion C.

The scooped portion 50 and the connection portion C between the upper arc portion 51a and the lower arc portion 51b can be provided at any position of the buttress portion 18. It is preferable that the scooped portion 50 is arranged such that between the arc portions 51a and 51b, the lower arc portion 51b which is provided closest to the tire radial inner side Ri overlaps at least a part of the end portion of the belt 26 in a tire radial direction R. In other words, it is preferable to arrange the scooped portion 50 so that at least a part of the end of the belt 26 is located on the tire width inner side Wi of the lower arc portion 51b. More preferably, as illustrated in FIG. 2, the scooped portion 50 is disposed such that the connection portion C between the upper arc portion 51a and the lower arc portion 51b overlaps the end portion of the fourth belt 26D located closest to the tire radial outer side Ro in the tire radial direction R.

It is preferable that a ratio p (=M/L) of a length M from the tire equatorial plane CL to the connection portion C between the upper arc portion 51a and the lower arc portion 51b and a length L from a tire width center portion (that is, the tire equatorial plane CL) to a tire width end of the widest second belt 26B is set to 1.03 or more and 1.11 or less. By setting the ratio p to 1.03 or more, the rubber thickness can be sufficiently secured from the end portion of the belt 26 to the bottom surface of the scooped portion 50 and the tread rubber is hardly peeled from the end portion of the belt 26. By setting the ratio p to 1.11 or less, the sinking amount of the scooped portion 50 can be sufficiently secured and the ground contact pressure in the vicinity of the ground contact end E can be reduced.

It is preferable that a tangent n to the tire radial outer end 50a of the scooped portion 50 is inclined to the tire width inner side Wi regarding the tire radial direction R and an angle θ regarding the tire radial direction R be set to be larger than 10 degrees and smaller than 35 degrees. By setting the angle θ to be larger than 10 degrees, the sinking amount of the scooped portion 50 can be sufficiently secured and the ground contact pressure in the vicinity of the ground contact end E can be reduced. By setting the angle θ to be smaller than 35 degrees, the strain caused by the load received in the vicinity of the ground contact end E of tread portion 16 is less likely to be concentrated on the connection portion C formed on the bottom surface of the scooped portion 50, and thus crack generation can be prevented.

The above-mentioned dimensions in the present specification are dimensions in the unloaded normal condition in which the pneumatic tire is mounted on a regular rim and filled with the regular internal pressure, unless otherwise specified. In the present specification, the ground contact end E is a tire width end portion of the tread surface in contact with a road surface in a normal load condition where the pneumatic tire is mounted on a normal rim, placed vertically on a flat road surface in a state of being filled with a normal internal pressure, and applied with a normal load.

The normal rim is a rim that the standard defines for each tire in a standard system including the standard on which the tire is based and, for example, it is a standard rim for JATMA, a “Design Rim” for TRA, and a “Measuring Rim” for ETRTO. The normal internal pressure is the air pressure that each standard defines for each tire in the standard system including the standard on which the tire is based and it is the maximum air pressure for JATMA, the maximum value described in the table “TIRE LOAD LIMITS AT VARIOUS COLD INFLATION PRESSURES” for TRA, and the “INFLATION PRESSURE” for ETRTO. For example, when the tire size is 295/75R22.5 (LR=G), it is set as 760 kPa. The normal load is a load defined by each standard for each tire in the standard system including the standard on which the tire is based and it is the maximum load capacity for JATMA, the maximum value described in the above table for TRA, the “LOAD CAPACITY” for ETRTO. It corresponds to 88% of the load described above when the tire is for a passenger car.

In the pneumatic tire 10 of the present embodiment as described above, the buttress portion 18 is provided with the scooped portion 50 which sinks toward the tire width inner side Wi. Therefore, the rigidity in the vicinity of the ground contact end E of the tread portion 16 can be reduced for the improvement (equalization of ground contact pressure distribution over the entire ground contact surface) of the grounding property in the vicinity of the ground contact end E, and thus the occurrence of uneven wear can be reduced.

The bottom surface of the scooped portion 50 is constituted of the upper arc portion 51a and the lower arc portion 51b and the cross-sectional shape of the bottom surface of the scooped portion 50 has a curved shape in which a plurality of arcs of different radii of curvature are arranged such that the radius of curvature decreases as it goes from the tire radial outer side Ro to the inner side Ri and adjacent arcs are connected at contact points having a common tangent. Therefore, in the pneumatic tire 10, the strain caused by the load received in the vicinity of the ground contact end E of the tread portion 16 can be dispersed in a wide range of scooped portion 50, and thus the tire durability can be improved.

In the pneumatic tire 10 of the present embodiment, between the arc portions 51 and 52, the lower arc portion 51b which is provided closest to the tire radial inner side Ri overlaps the end portion of the belt 26 in the tire radial direction R. As a result, the end portion of the belt 26 is positioned on the tire width inner side Wi of the lower arc portion 51b, which has a small radius of curvature and is easily bent, and the bending deformation in the lower arc portion 51b is appropriately restricted, so the flexibility can be equalized throughout the scooped portion 50. Therefore, the strain caused by the load received in the vicinity of the ground contact end E of the tread portion 16 is likely to be dispersed throughout the scooped portion 50, and thus the tire durability can be further improved.

Since the scooped portion 50 is provided in the buttress portion 18 so that the connection portion C between the upper arc portion 51a and the lower arc portion 51b overlaps the end portion of the fourth belt 26D in the tire radial direction R, deformation can be restricted in the vicinity of the connection portion C of the lower arc portion 51b where bending deformation is particularly likely to occur. Therefore, the strain is more likely to be uniformly dispersed throughout the scooped portion 50, and thus the tire durability can be improved.

### Second Embodiment

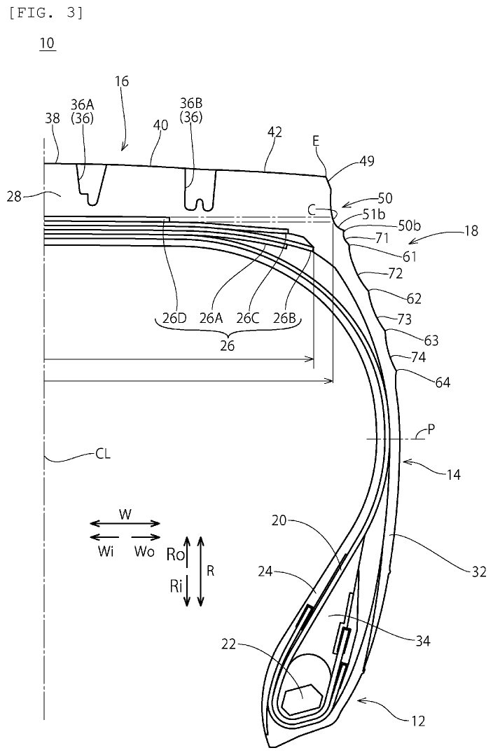

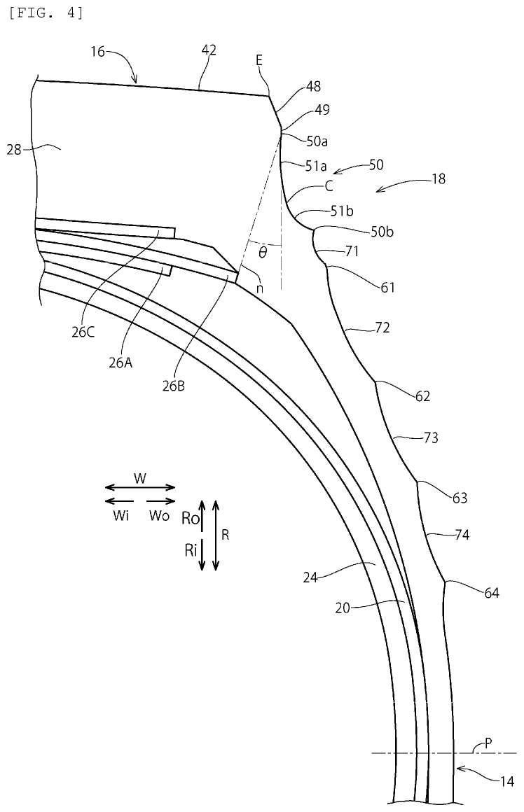

Next, a second embodiment of the present invention will be described with reference to FIGS. 3 and 4. The description of same parts as those of the first embodiment will be omitted and only different parts will be described.

In the present embodiment, a plurality of protrusions 61, 62, 63, and 64 and recess portions 71, 72, 73, and 74 defined by those protrusions 61, 62, 63, and 64 are provided in a portion between the tire radial inner side Ri of the scooped portion 50 provided in the buttress portion 18 to a tire maximum width position P.

The tire maximum width position P is a position on the outermost side of the surface of sidewall portion 14 in the tire width direction W and is a position on the surface of the sidewall portion which takes the tire maximum width. The tire maximum width is also referred to as a cross-sectional width and is a width excluding protrusions such as patterns and characters on the surface of the sidewall portions.

The plurality of protrusions 61, 62, 63, and 64 are protrusions which are provided substantially in parallel with each other, protruding from the outer surface of the buttress portion 18 to the tire width outer side Wo and extending along the tire circumferential direction.

A first protrusion 61 provided closest to the tire radial outer side Ro forms a first recess portion 71 extending along the tire circumferential direction with the tire radial inner side end 50b of the scooped portion 50. The first recess portion 71 includes an arc-shaped bottom surface of which the cross-sectional shape has a curvature radius r1.

A second protrusion 62 forms a second recess portion 72 extending along the tire circumferential direction with the first protrusion 61 adjacent to the tire radial outer side Ro. The second recess portion 72 includes an arc-shaped bottom surface of which the cross-sectional shape has a curvature radius r2.

A third protrusion 63 forms a third recess portion 73 extending along the tire circumferential direction with the second protrusion 62 adjacent to the tire radial outer side Ro. The third recess portion 72 includes an arc-shaped bottom surface of which the cross-sectional shape has a curvature radius r3.

A fourth protrusion 64 forms a fourth recess portion 74 extending along the tire circumferential direction with the third protrusion 63 adjacent to the tire radial outer side Ro. The fourth recess portion 74 includes an arc-shaped bottom surface of which the cross-sectional shape has a curvature radius r4.

The first recess portion 71, the second recess portion 72, the third recess portion 73, and the fourth recess portion 74 are provided substantially parallel to each other along the tire circumferential direction, in this order from the first recess portion 71 toward the tire radial inner side Ri, and aligned in the tire radial direction R in this order.

The curvature radii r1, r2, and r3 of the arcs forming the bottom surfaces of the first recess portion 71, the second recess portion 72, and the third recess portion 73 become gradually larger as the recess portion is located closer to the tire radial inner side Ri (that is, r1<r2<r3) and the curvature radius r4 forming the bottom surface of the fourth recess portion 74 is set to the same size as the curvature radius r3 of the arc of the bottom surface of the third recess portion 73.

In the present embodiment, since the recess portions 71, 72, 73, and 74 extending along the tire circumferential direction defined by a plurality of protrusions 61, 62, 63, and 64 are provided between the tire radial inner side Ri of the scooped portion 50 and the tire maximum width position P, the strain generated by the load received in the vicinity of the ground contact end E of the tread portion 16 can be distributed not only to the scooped portion 50 but also to the recess portions 71, 72, 73, and 74. Therefore, the tire durability can be improved while preventing the occurrence of uneven wear in the vicinity of the ground contact end of tread portion.

In the present embodiment, since the cross-sectional shape of the bottom surface of the recess portion located closer to the tire radial inner side Ri forms an arc shape having a large curvature radius and the shape of buttress portion 18 changes smoothly in the tire radial direction R, the scooped portion 50 and the plurality of recess portions 71, 72, 73, and 74 can be provided in the buttress portion 18 while reducing visual discomfort.

### Modification Example

The embodiments described above are presented as examples and are not intended to limit the scope of the invention. This novel embodiment can be implemented in other various forms and various omissions, replacements, and changes can be made without departing from the scope of the invention.

For example, in the embodiment described above, a case where the bottom surface of the scooped portion 50 is constituted of two arcs having different curvature radii is described. However, the bottom surface of the scooped portion 50 may have a curved shape in which three or more arcs are arranged so that the radii of curvature decreases as it goes from the tire radial outer side to the inner side and adjacent arcs are connected at contact points having a common tangent.

The scooped portion 50 may be an annular shape completely continuous in the tire circumferential direction or may be intermittent in some places in the circumferential direction.

The invention can be suitably used for high load pneumatic tires such as for trucks and buses, but is not limited to this, and can be used for various pneumatic tires for passenger cars and light trucks.

What is claimed is:

1. A pneumatic tire, comprising:
a tread portion, a sidewall portion, a buttress portion provided between the tread portion and the sidewall portion, and a scooped portion which sinks from an outer surface of the buttress portion to a tire width inner side, wherein
a cross-sectional shape of a bottom surface of the scooped portion forms a curved shape in which a plurality of arcs having different radii of curvature are arranged such that the radii of curvature decreases as it goes from a tire radial outer side to an inner side and adjacent arcs are connected at contact points having a common tangent.

2. The pneumatic tire according to claim 1, wherein
the tread portion includes a belt, and
a part of a bottom surface of the scooped portion, which is a portion formed with an arc having the smallest radius of curvature, is formed at a position overlapping with at least a part of an end portion of the belt in the tire radial direction.

3. The pneumatic tire according to claim 1, further comprising:
a plurality of protrusions provided along a tire circumferential direction in a portion between a tire radial inner side of the scooped portion and a tire maximum width position and recess portions formed by the protrusions and extending along the tire circumferential direction.

4. The pneumatic tire according to claim 3, further comprising:
a plurality of the recess portions provided side by side in the tire radial direction.

5. The pneumatic tire according to claim 4, wherein
a cross-sectional shape of a bottom surface of the recess portion located closer to the tire radial inner side has an arc shape with a larger radius of curvature.

6. The pneumatic tire according to claim 1, wherein
the tread portion includes a belt,
a cross-sectional shape of a bottom surface of the scooped portion has a curved shape in which two arcs having different radii of curvature are connected, and
a ratio M/L of a length M from a tire width center to a position at which two arcs are connected in a bottom surface of the scooped portion and a length L from the tire width center to a belt end located closest to a tire width outer side is set to 1.03 or more and 1.11 or less.

7. The pneumatic tire according to claim 1, wherein
an angle between a tangent to a tire radial outer end of the scooped portion and a tire radial direction is less than 35 degrees.

8. The pneumatic tire according to claim 1, wherein
the tire is a tire for truck or bus.

9. The pneumatic tire according to claim 2, further comprising:
a plurality of protrusions provided along a tire circumferential direction between a tire radial inner side of the scooped portion and a tire maximum width position and recess portions formed by the protrusions extending along a tire circumferential direction.
